(19) United States
(12) Patent Application Publication
(10) Pub. No.: US 2011/0233134 A1
(43) Pub. Date: Sep. 29, 2011

(54) Feedwell Assembly for Clarifier

(75) Inventor: Michael Robert, Napoleonville, LA (US)

(73) Assignee: LULA-WESTFIELD, LLC, Paincourtville, LA (US)

(21) Appl. No.: 12/975,019

(22) Filed: Dec. 21, 2010

Related U.S. Application Data
(60) Provisional application No. 61/288,549, filed on Dec. 21, 2009.

(51) Int. Cl. B01D 21/24

(52) U.S. Cl. 210/519

(57) ABSTRACT

A feedwell assembly is provided to assist in evenly distributing a source liquid to a clarifier and for dissipating the energy of the source liquid during flocculation is provided. The feedwell assembly comprises a downwardly extending influent pipe providing a source liquid containing solids. An outer pipe surrounds a portion of the influent pipe, and the outer pipe includes a closed bottom end and defines an annulus around the influent pipe. A feedwell is formed around the upper opening of the annulus, wherein the feedwell includes a circumferential wall and a floor. A plurality of down pipes are circumferentially spaced around the outer pipe and fluidically connected to the floor of the feedwell. A plurality of weirs extend from the outer pipe and are concentric with the annulus, wherein the weirs are adapted to evenly distribute the source liquid to the down pipes.

### CROSS-REFERENCE TO RELATED APPLICATIONS

This nonprovisional patent application claims priority under 35 U.S.C. §119 to U.S. Provisional Application Ser. No. 61/288,549, filed on Dec. 21, 2009.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to feedwell devices used to distribute influent into a clarifier, and more particularly to such devices which assist in dissipating the energy of the influent as it enters the clarifier.

2. Description of Related Art

Physical and chemical clarification of raw mixed sugar juice is currently practiced in the sugar industry by the addition of lime and sometimes, additional substances that cause a precipitate to form within the raw mixed sugar juice. This precipitate, sometimes including a polyelectrolyte flocculant, entraps suspended impurities in the raw mixed sugar juice. Due to the difference in densities between the precipitate and the clear sugar juice; the precipitate sinks to the lower region of the conventional clarifiers used in the industry. The clear sugar juice, due to its lower density, rises to take-off points in the upper section of conventional clarifiers.

Although there are a variety of clarifier designs currently being used in the industry, they all have a common operational disadvantage. The raw mixed sugar juice requires even and gentle distribution into the clarifier tank together with an equally even and gentle extraction of the clear sugar juice and precipitate in order to permit vertical rising of the clear sugar juice and vertical settlement of the precipitate in a turbulence-free environment.

This condition of turbulence-free vertical “plug flow” is practically impossible to achieve with the current designs of fixed, multi-point inlet and outlet facilities for the incoming raw mixed sugar juice and outgoing clear sugar juice and precipitate. Pure plug flow would necessitate an infinite number of inlet and outlet facilities spread over the entire cross section plan of the clarifier vessel.

Conventional clarifiers consequently operate on a compromise between vertical plug flow and horizontal flow, which is necessary in order to distribute and extract the juice and precipitate into and out of the clarifier tank. The turbulence caused by the interaction of vertical and horizontal flow patterns results in flow short-circuiting and semi-stagnant zones within the contents of the clarifier. Flow short-circuiting and semi-stagnant zones produce a variation in the residence time of the sugar juice in the clarifier. This turbulent condition also affects the gravitational rate of settlement of the precipitate, thus requiring a larger volume for settlement than a volume free from turbulence. A larger volume clarifier results in a longer average retention time for sugar juice in the clarifier. Sugar juice degrades with time and a loss of sucrose through inversion takes place. Therefore the shortest retention time of sugar juice in a clarifier is a distinct production advantage.

Over the years, a number of feedwell devices have been developed to distribute source liquids to clarifier tanks, including U.S. Pat. No. 6,276,537 to Esler; U.S. Pat. No. 7,160,394 to Wright; and U.S. Pat. No. 6,800,209 to Wright. While these devices may be suited to their specific applications, they do not provide the benefits achievable through use of the present invention.

What is generally needed is a feedwell device for clarifiers which dissipates the energy of the influent source liquid and evenly distributes the source liquid to the clarifier with minimal turbulence and short-circuit currents. The device should be easily retrofitted to existing clarifier tanks, and should not interfere with proper flocculation of the solids and precipitates in the liquid. It should also facilitate the use of any number of down pipes which can be positioned within the clarifier to achieve the most uniform and non-turbulent introduction of source liquid. Such a feedwell should also serve as a general purpose flow divider for a wide range of flow distribution applications in which the head pressure above each distribution line can be managed to suit the needs of each flow destination.

### SUMMARY OF THE INVENTION

A feedwell assembly for a clarifier having a clarified liquid level is provided, comprising a downwardly extending influent pipe providing a source liquid containing solids; an outer pipe surrounding a portion of the influent pipe and, wherein the outer pipe includes a closed bottom end and defines an annulus around the influent pipe, and wherein the annulus includes an upper opening; a feedwell formed around the upper opening of the annulus, wherein the feedwell includes a circumferential wall and a floor; a plurality of down pipes circumferentially spaced around the outer pipe and fluidically connected to the floor of the feedwell; and a plurality of weirs extending from the outer pipe and concentric with the annulus, wherein the weirs are adapted to evenly distribute the source liquid to the down pipes.

The influent pipe of the feedwell assembly should accept the introduction of a flocculating liquid. The invention should find its greatest utility in applications involving the clarification of raw sugar juice, although many other applications are possible.

The influent pipe includes an outlet, and wherein the outlet is adjacent to the bottom end of the outer pipe. Also, the down pipes are positioned within the clarifier to deliver the source liquid in a predetermined pattern.

In a preferred embodiment, the number of weirs is equal to the number of down pipes, and each of the weirs is aligned with one of the down pipes. More preferably, the weirs comprise V-shaped weirs.

The bottom end of the outer pipe and the upper opening of the annulus define a height H, and the feedwell assembly is positioned adjacent to the clarifier such that the clarified liquid level is within height H.

Also, a multi-purpose flow divider is also provided, comprising a downwardly extending influent conduit providing a source liquid; an outer conduit surrounding a portion of the influent conduit and, wherein the outer conduit includes a closed bottom end and defines an annulus around the influent conduit, and wherein the annulus includes an upper opening; a flow dividing section formed around the upper opening of the annulus, wherein the flow dividing section includes a plurality of notches adapted to evenly distribute the source liquid; a plurality of head development wells disposed around the outer conduit and below the notches, wherein each head development well includes a well volume; and at least one down pipe fluidically connected to each of the head development wells.

In a preferred embodiment, the flow dividing section is concentric with the upper opening of the annulus.

In another embodiment, the volume or shape of each of the head development wells is predetermined based upon a desired head pressure corresponding to the respective down pipe.

More preferably, the notches can be different shapes, namely V-shaped, rectangular, or other shapes.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 shows an elevation view of the feedwell assembly in accordance with one embodiment of the present invention.

FIG. 2 shows a top view of the embodiment of FIG. 1.

FIG. 3 shows an elevation view of the manner in which the invention may be positioned relative to the clarifier tank.

FIG. 4 shows a top schematic view of a desired pattern of distribution of the source liquid within the clarifier.

FIGS. 5A and 5B show sectional views of a generalized flow divider.

FIG. 6 shows a perspective view of an alternate embodiment of the flow divider of FIG. 5A having rectangular weir notches.

FIG. 7 shows a partial sectional view of the flow divider of FIG. 6.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

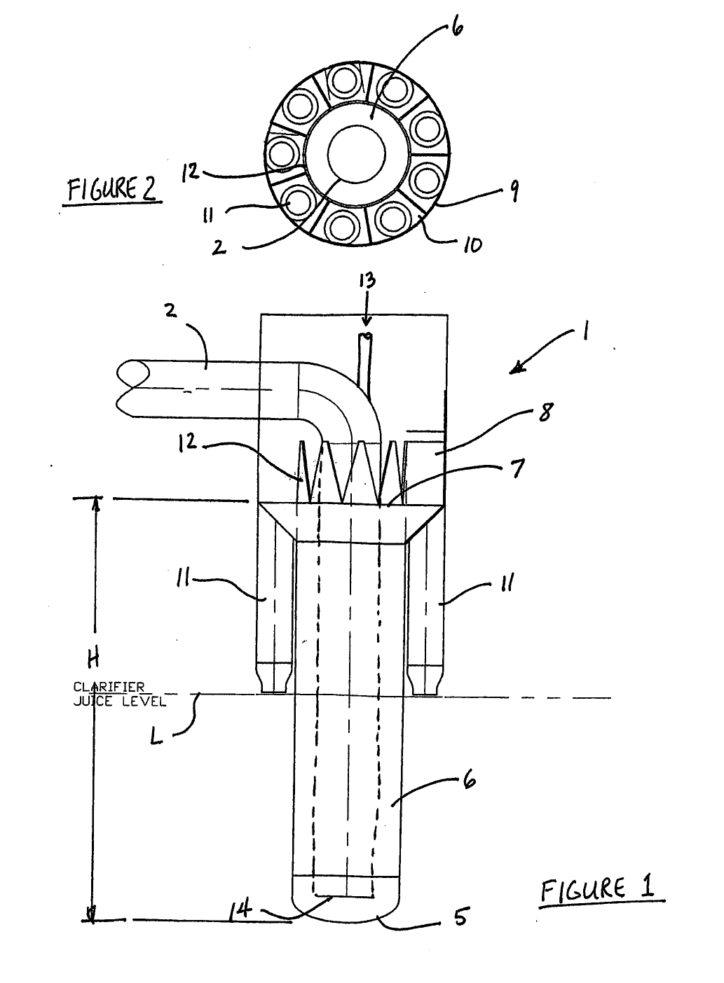

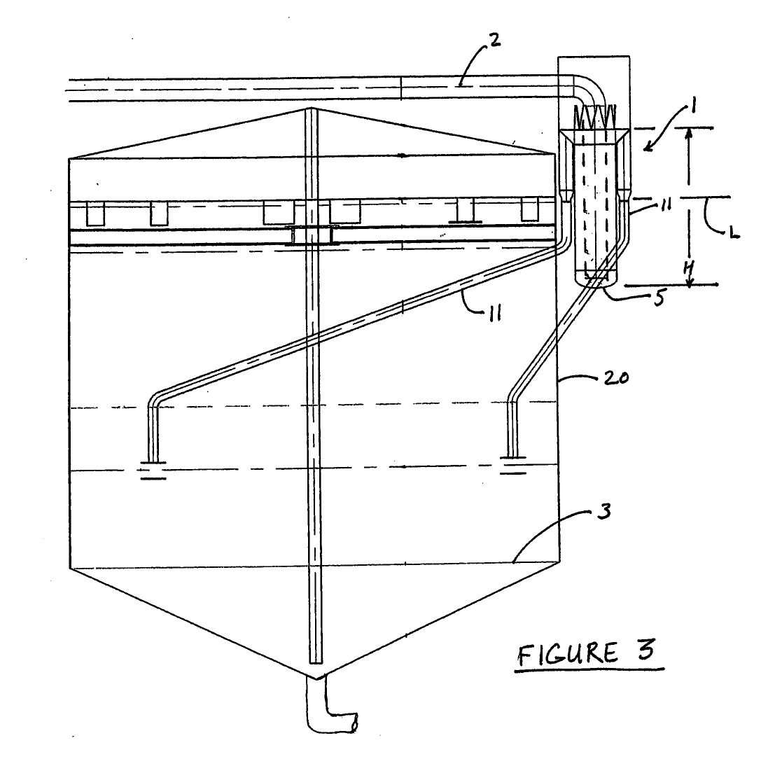

Turning now to FIGS. 1 through 3, the feedwell assembly 1 includes a downwardly extending influent pipe 2 providing a source liquid containing solids 3. An outer pipe 4 surrounds a portion of the influent pipe 2, and the outer pipe 4 includes a closed bottom end 5 and defines an annulus 6 around the influent pipe 2. The annulus 6 further includes an upper opening 7. A feedwell 8 is formed around the upper opening 7 of the annulus 6, wherein the feedwell 8 includes a circumferential wall 9 and a floor 10.

A plurality of down pipes 11 are circumferentially spaced around the outer pipe 4 and fluidically connected to the floor 10 of the feedwell 8. Furthermore, a plurality of weirs 12 extend from the outer pipe 4 and are concentric with the annulus 6, wherein the weirs 12 are adapted to evenly distribute the source liquid to the down pipes 11.

The influent pipe 2 of the feedwell assembly 1 should accept the introduction of a flocculating liquid 13. The invention should find its greatest utility in applications involving the clarification of raw sugar juice, although many other applications are possible.

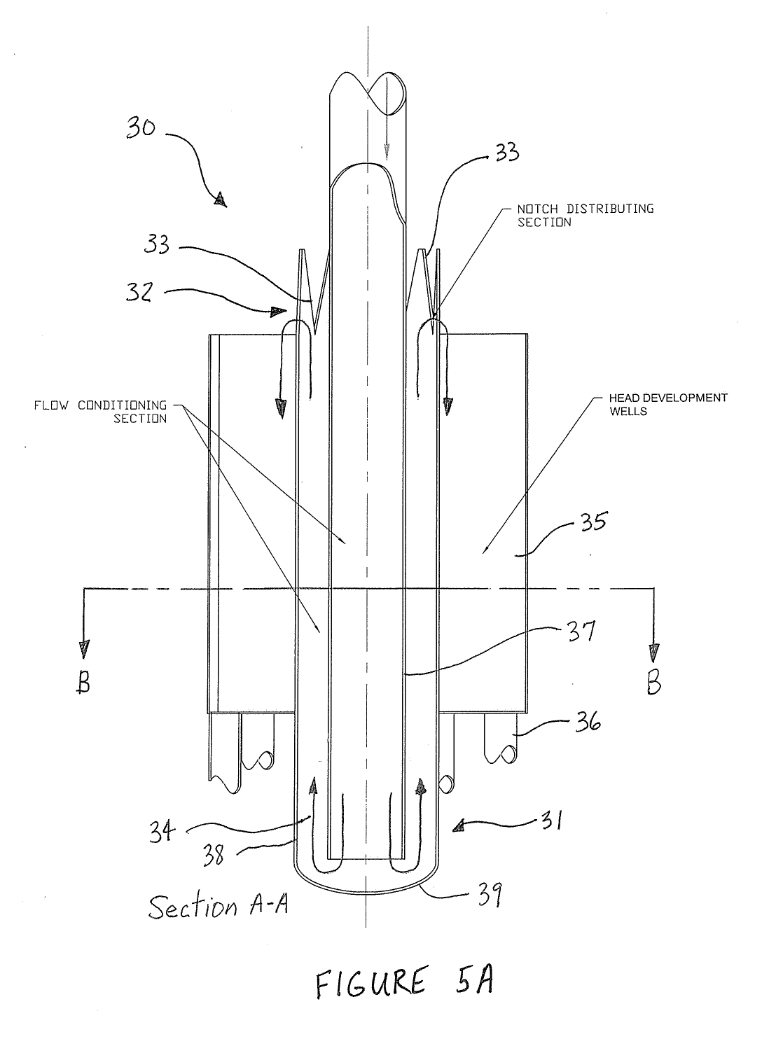

The influent pipe 2 includes an outlet 14, wherein the outlet 14 is adjacent to the bottom end 9 of the outer pipe 4. Also, the down pipes 11 are positioned within the clarifier to deliver the source liquid in a predetermined pattern. FIG. 4 illustrates one example of a distribution pattern that may be achieved with the arrangement shown in FIGS. 1-3.

In a preferred embodiment, the number of weirs 12 is equal to the number of down pipes 11, and each of the weirs 12 is aligned with one of the down pipes 11. More preferably, the weirs 12 comprise V-shaped weirs.

The bottom end 5 of the outer pipe 4 and the upper opening 7 of the annulus 6 define a height H, and the feedwell assembly 1 is positioned adjacent to the clarifier 20 such that the clarified liquid level L is within height H.

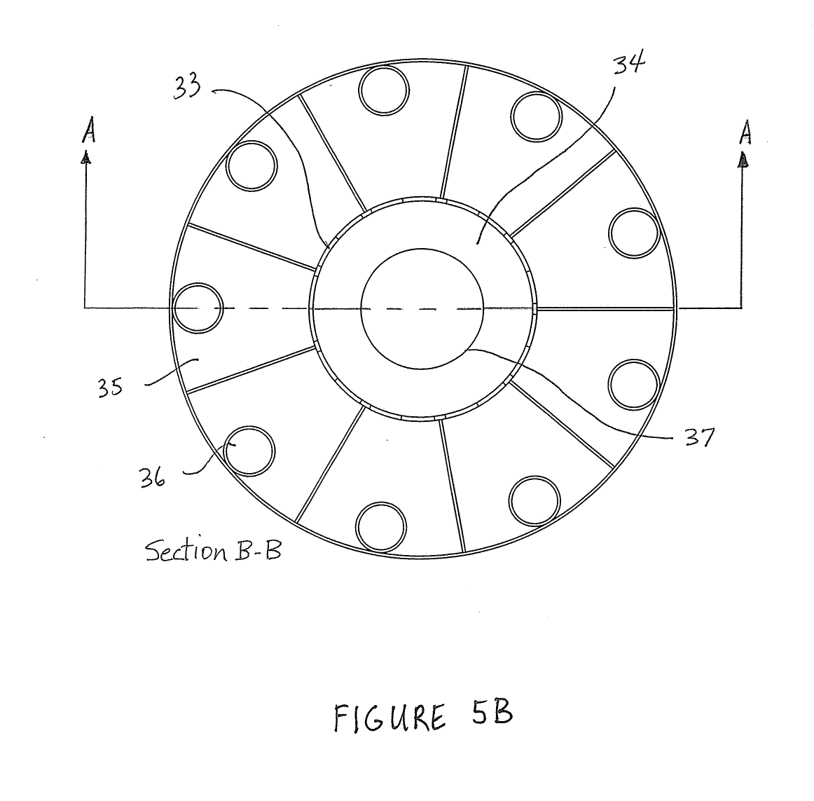

In a broader sense, and without regard to feedwells or the use with clarifiers, the present invention can be regarded as simply an improved flow divider 30, such as shown in FIGS. 5A and 5B. The flow divider 30 actively divides flow and allows each evenly divided stream to develop the necessary head required to ensure the delivery of each of the flow streams. The flow divider 30 is made up of two sections, the first being the flow conditioner 31, and the second is the notched divider section 32.

The flow conditioner section 31 comprises a central influent conduit 37 which flows into an annular conduit 38 with a closed bottom 39. This design quiets turbulence and transforms asymmetrical flow patterns to symmetrical laminar flow patterns through relatively long runs of a coaxial duct 34, similar to the design of FIG. 1.

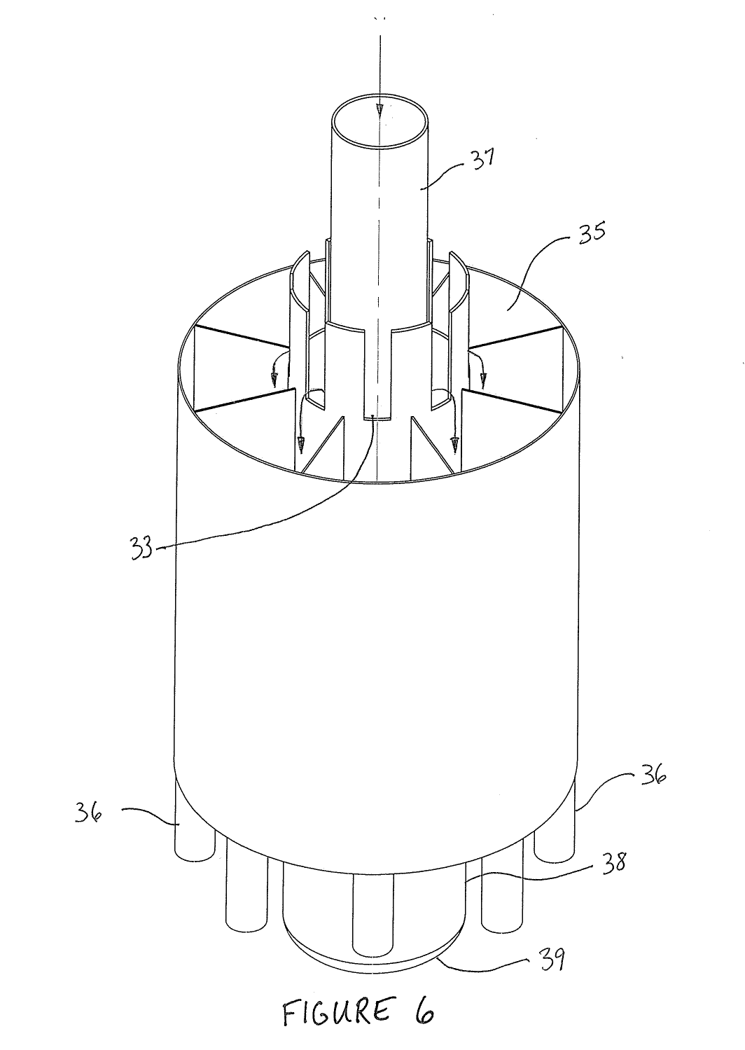

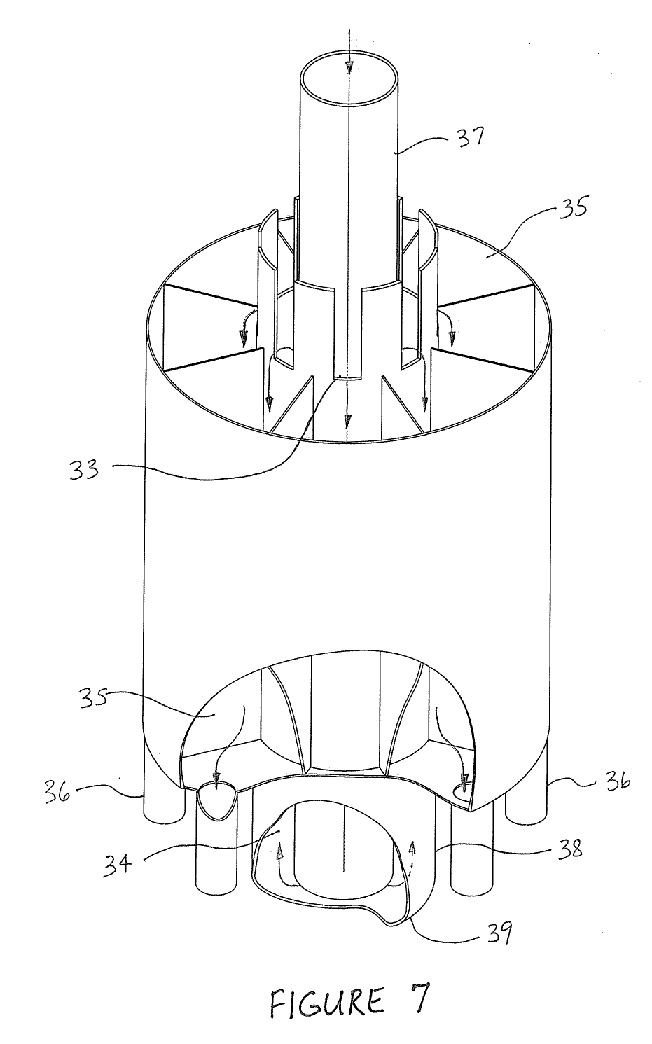

The flow dividing section 32 is an arrangement of evenly spaced and equally sized notches 33. As the flow moves through the flow conditioning section 31, it wells up to and out of the notches 33. The notches 33 will each discharge an approximately equal flow as long as the level on each notch 33 remains equal. Establishing such equal levels for the notches 33 is the function of the flow conditioning section 31. The fluid, upon exiting the notches 33 is now evenly divided and exits the flow dividing section 32 of the flow divider 30. FIG. 5A depicts the flow dividing section having V-shaped notches, although other shapes may be equally suitable, such as the rectangular shaped notches of FIGS. 6 and 7.

The head development wells 35 are compartments situated below the outflow of each notch 33 and are separated from each other around the circumference of the annular conduit 38. The wells 35 are intended for a gravity flow system, but may work with a pumped divided flow system. The level inside each well 35 must be sufficiently below its respective notch 33 to avoid the interference of free flow through the notch 33. The well 35 allows each of the individual divided flows to develop the required head to push the flow to its destination. This may be necessary even in the case that piping or ducts 36 are designed to be symmetrical, because of irregular construction or in the event of an obstruction.

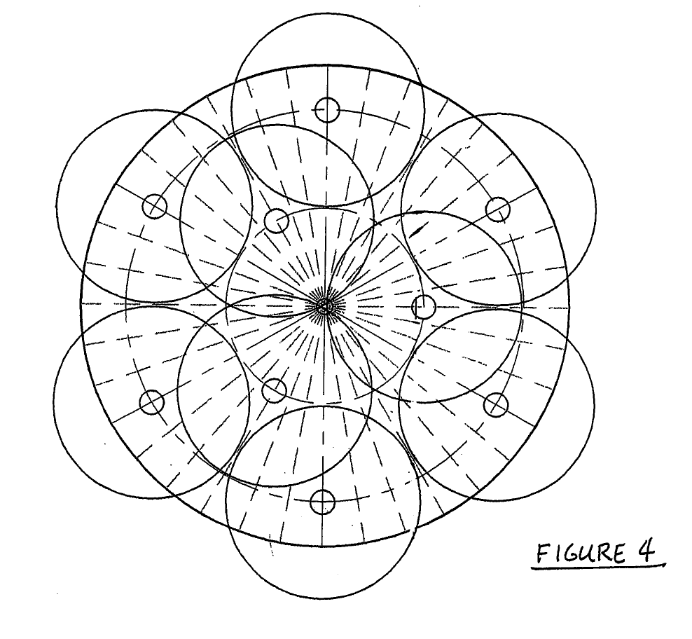

Most important, the head development wells 35 allow divided flows to travel different geometrical paths which require various head pressures to achieve the flow rates. Thus, the head pressure for each well 35 may be different, depending upon the attached pipe 36 and destination. For example, openings at the bottom of each well 35 and the diameter of its respective pipe 36 may be larger or smaller, as required for the desired head pressure and known flow over the notch 33. Likewise, the volume (or shape or various dimensions) of each well 35 may be increased or decreased to account for the desired head pressure. Thus, the evenly sized and spaced wells 35 shown in FIG. 5B may be altered as described to accommodate higher head pressures for some flows and lower head pressure for other flows. In this manner, longer runs or different geometric paths of pipe 36 can be used for remote locations without sacrificing even distribution of flows to the intended destination, as is shown in FIG. 3 in the case of a clarifier.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A feedwell assembly for a clarifier having a clarified liquid level, comprising:
(a) a downwardly extending influent pipe providing a source liquid containing solids;
(b) an outer pipe surrounding a portion of the influent pipe and, wherein the outer pipe includes a closed bottom end and defines an annulus around the influent pipe, and wherein the annulus includes an upper opening;
(c) a feedwell formed around the upper opening of the annulus, wherein the feedwell includes a circumferential wall and a floor;
(d) a plurality of down pipes circumferentially spaced around the outer pipe and fluidically connected to the floor of the feedwell; and
(e) a plurality of weirs extending from the outer pipe and concentric with the annulus, wherein the weirs are adapted to evenly distribute the source liquid to the down pipes.

2. The assembly of claim 1, wherein the influent pipe further includes a flocculating liquid.

3. The assembly of claim 1, wherein the source liquid is raw sugar juice.

4. The assembly of claim 1, wherein the influent pipe includes an outlet, and wherein the outlet is adjacent to the bottom end of the outer pipe.

5. The assembly of claim 1, wherein the down pipes are positioned within the clarifier to deliver the source liquid in a predetermined pattern.

6. The assembly of claim 1, wherein the number of weirs is equal to the number of down pipes, and wherein each of the weirs is aligned with one of the down pipes.

7. The assembly of claim 1, wherein the weirs comprise V-shaped weirs.

8. The assembly of claim 1, wherein the bottom end of the outer pipe and the upper opening of the annulus define a height H, and wherein the feedwell assembly is positioned adjacent to the clarifier such that the clarified liquid level is within height H.

9. A flow divider, comprising:
(a) a downwardly extending influent conduit providing a source liquid;
(b) an outer conduit surrounding a portion of the influent conduit and, wherein the outer conduit includes a closed bottom end and defines an annulus around the influent conduit, and wherein the annulus includes an upper opening;
(c) a flow dividing section formed around the upper opening of the annulus, wherein the flow dividing section includes a plurality of notches adapted to evenly distribute the source liquid;
(d) a plurality of head development wells disposed around the outer conduit and below the notches, wherein each head development well includes a well volume; and
(e) at least one down pipe fluidically connected to each of the head development wells.

10. The flow divider of claim 10, wherein the flow dividing section is concentric with the upper opening of the annulus.

11. The flow divider of claim 10, wherein the volume or shape of each of the head development wells is predetermined based upon a desired head pressure corresponding to the respective down pipe.

12. The flow divider of claim 10, wherein the notches are V-shaped.

13. The flow divider of claim 10, wherein the notches are rectangular in shape.
